(19) United States
(12) Patent Application Publication
(10) Pub. No.: US 2026/0257153 A1
(43) Pub. Date: Sep. 3, 2026

(54) SETTLING ASSEMBLY FOR DECANTING AN EFFLUENT

(71) Applicant: SUEZ INTERNATIONAL, Puteaux (FR)

(72) Inventors: Laurence DUMOULIN, Paris (FR); Nathalie GRUEL, Paris (FR); Olivier BREMOND, Paris (FR); Pedro DA FONSECA, Paris (FR); Olivier HUBER, Paris (FR); Benjamine D'ELBEE, Paris (FR); Rui GABRIEL, Paris (FR)

(21) Appl. No.: 19/490,021

(22) PCT Filed: Jun. 7, 2024
(86) PCT No.: PCT/EP2024/065743

§ 371 Date: Dec. 4, 2025

(30) Foreign Application Priority Data
Jun. 8, 2023 (FR) FR2305772

(51) Int. Cl. B01D 21/00; B01D 21/24

(52) U.S. Cl. CPC B01D 21/0003; B01D 21/0012; B01D 21/2416

(57) ABSTRACT

A settling assembly for decanting an effluent including a settling tank, a supply device for supplying the settling tank with effluent, and a flow distribution and energy dissipation compartment capable of receiving the effluent directly from the supply device. The compartment is installed in the settling tank and delimited by at least a portion of the external wall of the settling tank, by at least one other liquid-tight lateral wall, and by a bottom wall perforated with a plurality of orifices, forming an intermediate volume. The plurality of orifices establish fluidic communication between the intermediate volume and the settling volume.

### FIELD OF THE INVENTION

The present invention relates to the field of treating water and, in particular, to a settling assembly for decanting an effluent.

### BACKGROUND

In particular, the invention relates to feeding effluent into a circular lamellar decanter.

Lamellar decanters are commonly used in effluent treatment to separate particles suspended in water.

However, it is relatively important to ensure uniform distribution of the incoming water flow and good dissipation of its energy to guarantee optimum operation of the lamellar decanter.

Existing effluent feed systems on circular structures therefore require costly adaptations, in particular in terms of civil engineering, to allow the effluent flow to be fed to the central part so as to achieve uniform flow distribution. In addition, such an effluent feed does not allow optimized control of the energy from the flow as it enters the settling tank, causing undesirable turbulence.

Thus, there is a need for a solution that allows an effluent flow to be fed into a circular settling tank and the energy from the fed-in effluent flow to be dissipated, allows improved flow distribution, and has a design which is relatively simple and inexpensive to achieve.

For this purpose, the invention proposes a settling assembly for decanting an effluent, comprising a settling tank and a supply device for supplying said settling tank with effluent,
said settling tank comprises a bottom and an external wall in the general shape of a straight circular cylinder delimiting a settling volume,
said settling assembly being characterized in that it comprises a flow distribution and energy dissipation compartment capable of receiving the effluent directly from the supply device, said compartment being installed in the settling tank and delimited by at least a portion of the external wall of the settling tank, by at least one other liquid-tight lateral wall, and by a bottom wall perforated with a plurality of orifices, forming an intermediate volume; said plurality of orifices establishing fluidic communication between the intermediate volume and the settling volume.

Due to the position of the flow distribution and energy dissipation compartment at the edge of the tank, it is thus relatively simple to deliver the effluent into the tank, while dissipating its energy and ensuring relatively optimal flow distribution. This therefore makes it possible to optimize dissipation of the energy required for the effluent to enter the circular decanter, while simplifying its delivery.

Advantageously, the assembly further comprises lamellar modules installed in said settling volume of said settling tank and launders for recovering settled water on the surface of said settling tank. In this way, flow through the perforated floor takes place by balancing the levels between the compartment and the settling tank.

Advantageously, said bottom wall of said flow distribution and energy dissipation compartment is mounted at a height from the bottom of the settling tank that is lower than the height of the recovery launders. In this way, better mixing can be achieved in the effluent present in the tank.

Advantageously, said bottom wall is mounted at a height from the bottom that is greater than or equal to two-thirds of the total height of the tank.

Advantageously, the orifices are uniformly distributed over the bottom wall. This allows improved flow distribution.

In particular, each orifice has a diameter of between 3 cm and 40 cm.

In particular, the orifices are spaced apart by 5 cm to 60 cm.

In particular, said portion of the external wall extends such that it forms an angle of between 20° and 160° with respect to the center of the tank between its ends.

### BRIEF DESCRIPTION OF THE DRAWINGS

Further features and advantages of the invention will become apparent from the following description of an embodiment of the invention, given by way of indication but not limitation, with reference to the appended drawings, in which:

FIG. 1 is a schematic side view of a settling assembly according to the main embodiment of the invention;

FIG. 2 is a schematic perspective view of the settling assembly according to the main embodiment of the invention;

FIG. 3 is a top view of the flow distribution and energy dissipation compartment of the settling assembly according to the main embodiment of the invention;

FIG. 4 is a perspective view of the flow distribution and energy dissipation compartment, with the external wall of the settling tank not shown;

FIG. 5 is a top view of the settling assembly according to the main embodiment of the invention.

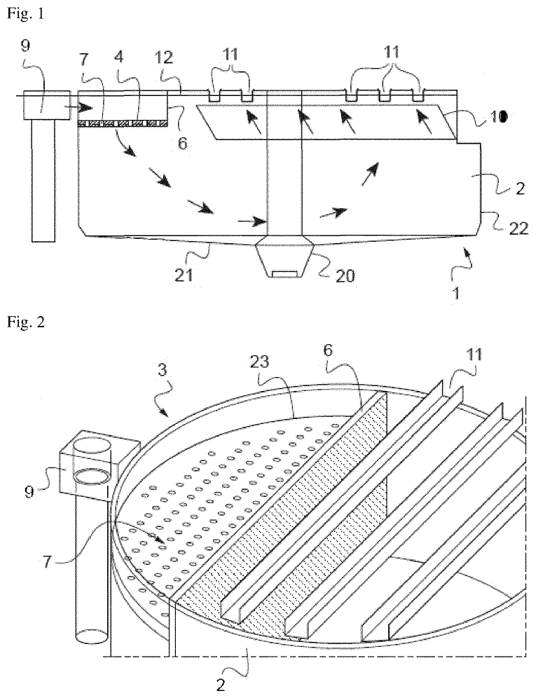

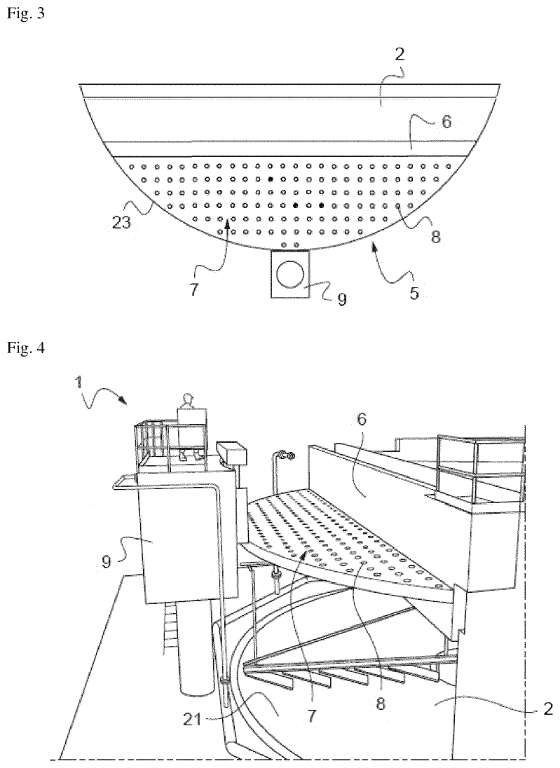

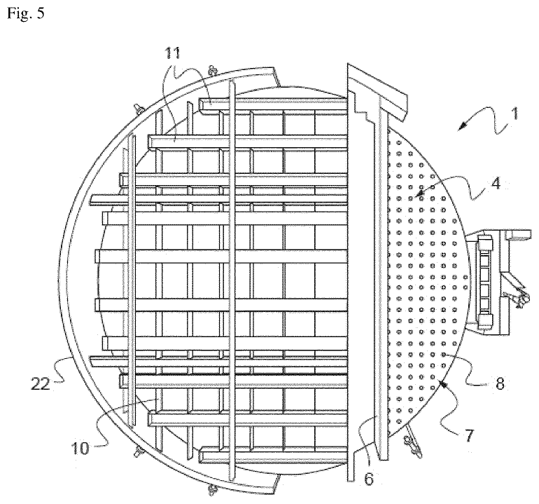

### DETAILED DESCRIPTION

In a first embodiment of the invention, a settling assembly 1 for decanting an effluent comprises a settling tank 2 and a supply device 9 for supplying said tank with effluent.

The settling tank 2 generally comprises at least one bottom 21 and an external wall 22 in the general shape of a straight circular cylinder defining a settling volume.

By way of example, such a tank can have a diameter ranging from 5 m to 30 m, and a depth, also known as a total height, of between 2 m and 10 m.

In this embodiment, as described below, the tank further comprises a trough 20 for recovering settled particles.

The settling assembly 1 comprises lamellar modules 10 installed in said settling tank 2, and launders 11 for recovering the settled water.

The lamellar modules 10 are known to be made up of lamellas, frequently with a “honeycomb” cross section, which can be inclined at an angle of between 45 and 60 degrees with respect to the horizontal so as to promote the separation and depositing of solid particles.

The effluent thus settles in the tank 2 by way of two mechanisms:

The heavier particles suspended in the effluent fall to the bottom of the tank due to gravity. A scraper bridge (not shown) then scrapes these particles and drops them into the recovery trough 20 which comprises a suction nozzle for collecting the particles. This settling is made possible by the low turbulence of the effluent in the tank 2, which in particular explains the desire to dissipate the energy from the effluent flow delivered into the tank 2.

The lightest particles suspended in the effluent are separated as the effluent passes through the lamellar modules, the operation of which is well known to a person skilled in the art. The clear water is then collected at the top of the lamellar modules by overflowing into the recovery launders 11.

These launders 11, the edges of which extend above the effluent level in the tank 2, have partially submerged openings so that the water leaving the lamellar modules flows into the recovery launders 11 through these openings.

In order to dissipate the energy from the effluent flow, while improving the distribution of the flow entering the tank 2, the assembly 1 comprises a flow distribution and energy dissipation compartment 4 which is intended to receive the effluent arriving from the supply device 9 before it enters the settling tank 2.

The supply device 9 for supplying said effluent may comprise distribution pipes, pumps or ducts to convey the effluent to the flow distribution and energy dissipation compartment 4.

The flow distribution and energy dissipation compartment 4 is located in the tank 2.

In other words, said compartment 4 is contained within the volume defined by the external wall 22 in the general shape of a straight circular cylinder.

This flow distribution and energy dissipation compartment 4 is formed by at least a portion 23 of the external wall 22 of the settling tank 2, and by a liquid-tight lateral wall 6 formed in said settling tank 2, forming an intermediate volume.

Viewed from above the tank 2, the lateral wall 6 thus takes the form of a chord to the circle formed by the external wall 22.

Viewed from above, the portion 23 of the external wall 22 extends over an arc forming an angle of between 20° and 160° with the center of the tank.

As for the lateral wall 6, it is positioned such that the surface area occupied by the compartment 4 is between 5% and 40% of the general surface area of the tank.

In other words, the lateral wall 6 extends on either side to the external wall 22.

However, the invention is not limited to a single lateral wall 6. The compartment 4 may be delimited by the portion 23 of the external wall 22 and by one or more lateral walls.

In addition, the lateral wall(s) 6 need not be planar, but can be curved, concave or convex, or any other shape which is suitable for the decanter.

The lamellar modules 10 are mounted in the tank outside the compartment 4, and preferably in an arrangement that allows a maximum distance between these lamellar modules 10 and the compartment 4 so as to limit the interactions between the fluids entering the tank 2 and the fluids rising toward the lamellar modules 10.

Accordingly, in this embodiment, the lamellar modules extend into the tank from an edge diametrically opposite the portion 23 of the external wall 22 of the compartment 4.

According to a cross-sectional view of the tank, viewed from above, the lateral wall 6 forms a chord of the circle delimiting the circumference of the tank 2 so that the contour of the compartment 4 is formed by the chord and by the arc of the circle delimited by the chord.

This flow distribution and energy dissipation compartment 4 comprises a bottom wall 7 perforated with a plurality of orifices 8 which open into the settling volume of the settling tank 2.

Thus, although the intermediate volume is contained within the settling volume, these two volumes are only in fluidic communication via the orifices 8 in the bottom wall 7.

In this embodiment, the bottom wall 7 extends substantially in parallel with the bottom 21 of the settling tank 2, which ensures an advantageous distribution of the effluent in the compartment 4.

However, the bottom wall 7 could also have a total or partial declination with respect to the bottom 21.

The supply device 9 discharges effluent into the compartment 4. This supply device 9 is installed and opens from the portion of the cylindrical surface 22 forming the flow distribution and energy dissipation compartment 4.

In other words, the supply device 9 for supplying the effluent opens from the circumference of the settling tank 2, which makes it possible to simplify the technical implementation of the delivery of the effluent, in particular in terms of civil engineering, in contrast to delivery in the center of the settling tank.

In this embodiment, the bottom wall 7, also known as the floor 7, closes off the entire compartment 4 at its lower part, i.e. opposite the bottom of the settling tank 2.

This bottom wall 7 is here made of concrete, but can be made of any other suitable material, be it plastics material, polymer materials, metals, or composites, suitable in particular for the type of effluent to be treated.

In the main embodiment of the invention, the thickness of the bottom wall depends on the material used.

The invention is not limited to a particular thickness, but can range from 1 mm to 50 cm depending on the material used.

The bottom wall 7 of the compartment 4 is shaped such that its level, or its height, with respect to the bottom 21 of the settling tank 2 is lower than a minimum level of effluent present in the settling tank under operating conditions.

Preferably, the bottom wall 7 is mounted at a height, starting from the bottom 21, that is greater than or equal to two-thirds of the total height of the tank 2 and less than the total height of the tank 2.

In other words, under operating conditions, the level of effluent 12 in the settling tank is higher than the level of the bottom wall 7 of the compartment 4.

In this way, the effluent in the flow distribution and energy dissipation compartment 4 enters the tank by balancing the effluent levels between the compartment 4 and the settling tank 2.

In particular, the water is extracted, as explained, by overflowing into the recovery launders 11, which makes it possible for the effluent contained in the compartment 4 to enter the tank 2.

Also, with respect to the bottom 21 of the tank 2, the level of the bottom wall 7 has a height that is lower than the height of the recovery launders 11.

This therefore makes it possible to effectively dissipate the energy from the effluent as it enters the settling tank and reduces hydrodynamic turbulence in the tank.

The bottom wall 7 comprises a plurality of orifices 8 which are distributed substantially uniformly over its entire surface.

These orifices 8 are sized to allow free passage of the effluent, while ensuring its energy is dissipated.

In the main embodiment of the invention, the orifices 8 are uniformly distributed over the bottom wall 7.

In one particular example, the orifices 8 can have a diameter of between 3 and 40 cm and can be spaced apart by 5 to 60 cm depending on the surface area of the bottom wall 7 and the properties of the effluent.

However, the invention is not limited to a uniform distribution of the orifices over the bottom wall 7.

In particular, the bottom wall 7 may comprise an orifice arrangement in a predefined pattern which is not regular.

However, care is taken to ensure that the orifices are arranged in a suitable pattern and size to ensure optimized distribution of the effluent flow in the settling tank at a desired flow rate.

1. A settling assembly for decanting an effluent, comprising a settling tank and a supply device for supplying said settling tank with effluent,
said settling tank comprises a bottom and an external wall in a general shape of a straight circular cylinder delimiting a settling volume,
said settling assembly comprises a flow distribution and energy dissipation compartment capable of receiving the effluent directly from the supply device, said compartment being installed in the settling tank and delimited by at least a portion of the external wall of the settling tank, by at least one other liquid-tight lateral wall, and by a bottom wall perforated with a plurality of orifices, forming an intermediate volume; said plurality of orifices establishing fluidic communication between the intermediate volume and the settling volume.

2. The settling assembly according to claim 1, further comprising lamellar modules installed in the settling volume of said settling tank and launders for recovering the water settled on a surface of said settling tank.

3. The settling assembly according to claim 2, wherein said bottom wall of said flow distribution and energy dissipation compartment is mounted at a height from the bottom of the settling tank that is lower than the height of the launders.

4. The settling assembly according to claim 3, wherein said bottom wall is mounted at a height from the bottom that is greater than or equal to two-thirds of a total height of the tank.

5. The settling assembly according to claim 1, wherein the orifices are uniformly distributed over the bottom wall.

6. The settling assembly according to claim 1, wherein each orifice has a diameter of between 3 cm and 40 cm.

7. The settling assembly according to claim 1, wherein the orifices are spaced apart by 5 cm to 60 cm.

8. The settling assembly according to claim 1, wherein said portion of the external wall extends such that it forms an angle of between 20° and 160° with respect to a center of the tank between its ends.
